(19) United States
(12) Patent Application Publication
(10) Pub. No.: US 2004/0080424 A1
(43) Pub. Date: Apr. 29, 2004

(54) Flammable gas detection and garage atmosphere management system

(76) Inventors: Joseph Cohen Perry, Bethlehem, PA (US); David John Farese, Riegelsville, PA (US); Richard Layton Colwell, Macungie, PA (US)

Correspondence Address: AIR PRODUCTS AND CHEMICALS, INC., PATENT DEPARTMENT, 7201 HAMILTON BOULEVARD, ALLENTOWN, PA, 181951501

(21) Appl. No.: 10/278,826

(22) Filed: Oct. 23, 2002

(51) Int. Cl. G08B 17/10

(52) U.S. Cl. 340/632

(57) ABSTRACT

Method for detecting and controlling the concentration of a flammable gas in an enclosed space. The method includes providing a source of flammable gas to an enclosed space, wherein the enclosed space includes a device which consumes or stores the flammable gas, and wherein the enclosed space further includes unclassified electrical equipment and an electrical power supply to the unclassified electrical equipment. The atmosphere in the enclosed space is analyzed to determine the concentration of the flammable gas therein and this concentration is compared to a first reference concentration and a second reference concentration that is less than the first reference concentration. When the concentration of the flammable gas in the enclosed space is between the first and second reference concentrations, the source of flammable gas to the enclosed space is terminated and the enclosed space is ventilated. When the concentration of the flammable gas in the enclosed space is equal to or greater than the first reference concentration, the electrical power supply to the unclassified electrical equipment in the enclosed space is terminated.

### BACKGROUND OF THE INVENTION

New energy conversion systems and alternative fuels for motor vehicles and stationary power generation are being developed to supplement or replace conventional internal combustion engines that operate on gasoline or diesel fuel. These alternative fuels, which may include gases such as hydrogen and natural gas, can be generated or stored in enclosed spaces such as garages, sheds, and process buildings which house vehicles or power generation systems. Alternatively, these gaseous fuels may be delivered via pipeline into these enclosed spaces.

Hydrogen is the fuel of choice for fuel cells, and widespread use of hydrogen for this purpose is anticipated in coming years. Hydrogen may be stored within an enclosed space such as a garage in the fuel storage system of a parked vehicle that is fueled at an external commercial fueling station. Alternatively, hydrogen may be stored adjacent to a garage or process building and piped in to fill a vehicle storage system or to operate a stationary power generation system. In another alternative, hydrogen may be generated within an enclosed space such as a garage or process building by the electrolysis of water or by the reforming of hydrocarbons, with the generated hydrogen then used to fill a vehicle storage system or to operate a stationary power generation system. In any of these alternatives, leaks may occur which could release flammable gas into the enclosed space.

The safety requirements for the generation, storage, and handling of hydrogen are well-developed and widely practiced in the industrial gas and process industries. The safe operation of hydrogen generation, storage, and handling systems by small hydrogen users in garages or process buildings, however, will require the development of new safety procedures and equipment. This will be especially important because these systems may be operated by individuals who are generally unfamiliar with the safety aspects of hydrogen generation and use. In the future, many of these individuals may be owners and operators of vehicles powered by fuel cells wherein the vehicles are stored and possibly fueled in garages adjacent to their homes.

In view of the accelerating development of alternative fuels for motor vehicles and stationary power generation, there is a need for improved procedures and apparatus for the safe storage and handling of gaseous fuels such as hydrogen and light hydrocarbons in garages, process buildings, and other enclosed spaces. Embodiments of the present invention, which are described below and defined by the claims which follow, provide methods and systems for the detection and mitigation of gaseous fuel leaks in garages, process buildings, and other enclosed spaces.

### BRIEF SUMMARY OF THE INVENTION

A first embodiment of the invention relates to a method for detecting and controlling the concentration of a flammable gas in an enclosed space comprising providing a source of flammable gas to an enclosed space, wherein the enclosed space includes a device which consumes or stores the flammable gas, and wherein the enclosed space further includes unclassified electrical equipment and an electrical power supply to the unclassified electrical equipment. The atmosphere in the enclosed space is analyzed to determine the concentration of the flammable gas therein, and the concentration of the flammable gas determined is compared to a first reference concentration and a second reference concentration that is less than the first reference concentration. When the concentration of the flammable gas in the enclosed space is between the first and second reference concentrations, the source of flammable gas to the enclosed space is terminated and the enclosed space is ventilated. When the concentration of the flammable gas in the enclosed space is equal to or greater than the first reference concentration, the electrical power supply to the unclassified electrical equipment in the enclosed space is de-energized.

The concentration of the flammable gas may be determined as a % of the lower flammable limit (LFL) of the flammable gas in ambient air. Typically, the first reference concentration is greater than about 25% and less than 100% of the LFL and the second reference concentration is greater than about 5% of the LFL and equal to or less than the first reference concentration.

The flammable gas may be selected from the group consisting of hydrogen, methane, natural gas, propane, butane, and liquefied petroleum gas (LPG). In one option, the flammable gas is hydrogen, the first reference concentration is greater than about 25% and less than 100% of the LFL, and the second reference concentration is greater than about 5% of the LFL and equal to or less than the first reference concentration. The source of flammable gas may be a hydrogen generator selected from the group consisting of a water electrolysis unit and a hydrocarbon reforming unit. Alternatively, the source of the flammable gas may be a pipeline that transfers hydrogen into the enclosed space from a storage facility outside the enclosed space.

The enclosed space may be a garage and ventilation may be effected by opening a garage door and activating a ventilator fan.

The embodiment of the invention may further comprise comparing the concentration of the flammable gas to a third reference concentration which is less than the second reference concentration, and actuating a warning alarm when the concentration of the flammable gas in the enclosed space is equal to or less than the second reference concentration and greater than the third reference concentration. The embodiment may further comprise actuating a warning alarm when the concentration of the flammable gas in the enclosed space is between the first and second reference concentrations. The embodiment also may further comprise actuating a warning alarm when the concentration of the flammable gas in the enclosed space is equal to or greater than the first reference concentration.

Another embodiment of the invention includes a system for detecting and controlling the concentration of a flammable gas in an enclosed space comprising:

(a) means for providing a source of flammable gas to the enclosed space, wherein the enclosed space includes a device which consumes or stores the flammable gas, and wherein the enclosed space further includes unclassified electrical equipment and an electrical power supply to the unclassified electrical equipment;

(b) means for analyzing the atmosphere in the enclosed space to determine the concentration of the flammable gas therein;

(c) means for comparing the concentration of the flammable gas determined in (b) to a first reference concentration and a second reference concentration less than the first reference concentration;

(d) means for terminating the source of flammable gas to the enclosed space and ventilating the enclosed space in response to a first signal generated when the concentration of the flammable gas in the enclosed space is between the first and second reference concentrations; and

(e) means for de-energizing the power supply to the unclassified electrical equipment in response to a second signal when the concentration of the flammable gas in the enclosed space is equal to or greater than the first reference concentration.

Another embodiment includes a method for detecting and controlling the concentration of hydrogen in a garage in which hydrogen utilized, the method comprising:

(a) providing a source of hydrogen to the garage, wherein the garage includes a device which consumes or stores hydrogen, and wherein the garage further includes unclassified electrical equipment and an electrical power supply to the unclassified electrical equipment;

(b) analyzing the atmosphere in the garage to determine the concentration of hydrogen therein;

(c) comparing the concentration of hydrogen determined in (b) to a first reference concentration and a second reference concentration less than the first reference concentration;

(d) when the concentration of hydrogen in the enclosed space is between the first and second reference concentrations, terminating the source of hydrogen to the enclosed space and ventilating the garage; and

(e) when the concentration of hydrogen in the enclosed space is equal to or greater than the first reference concentration, de-energizing the power supply to the unclassified electrical equipment.

The concentration of hydrogen may be determined as a % of the lower flammable limit (LFL) of hydrogen in ambient air. The first reference concentration may be greater than about 25% and less than 100% of the LFL and the second reference concentration may be greater than about 5% of the LFL and equal to or less than the first reference concentration. The ventilation of the garage may be effected by opening a garage door and activating a ventilator fan.

In a final embodiment, the invention may include an automatic garage door opener and ventilator system for a garage in which a flammable gas is utilized, the system comprising:

(a) means for providing a source of flammable gas to the garage, wherein the enclosed space includes a device which consumes or stores the flammable gas, and further includes unclassified electrical equipment and an electrical power supply to the unclassified electrical equipment;

(b) means for analyzing the atmosphere in the enclosed space to determine the concentration of the flammable gas therein;

(c) means for comparing the concentration of the flammable gas determined in (b) to a first reference concentration and a second reference concentration less than the first reference concentration;

(d) means for terminating the source of flammable gas to the enclosed space in response to a first signal generated when the concentration of the flammable gas in the garage is between the first and second reference concentrations;

(e) a garage door and garage door opening means for opening the garage door in response to the first signal generated when the concentration of the flammable gas in the garage is between the first and second reference concentrations;

(f) a ventilator fan for discharging air from the garage in response to the first signal generated when the concentration of the flammable gas in the enclosed space is between the first and second reference concentrations; and

(e) means for de-energizing the power supply to the unclassified electrical equipment in response to a second signal when the concentration of the flammable gas in the garage is equal to or greater than the first reference concentration.

The flammable gas may be hydrogen, and the source of flammable gas may be a hydrogen generator selected from the group consisting of a water electrolysis unit and a hydrocarbon reforming unit. Alternatively, the source of the flammable gas may be a pipeline that transfers hydrogen into the enclosed space from a storage facility outside the enclosed space.

### BRIEF DESCRIPTION OF SEVERAL VIEWS OF THE DRAWINGS

FIG. 1 is a schematic circuit diagram for an embodiment of the present invention.

FIG. 2 is an exemplary decision analysis diagram for an embodiment of the present invention.

### DETAILED DESCRIPTION OF THE INVENTION

The embodiments of the present invention relate to methods and systems for the detection and mitigation of gaseous fuel leaks in enclosed spaces such as garages or process buildings. A fuel leak may originate, for example, from fuel stored in the fuel storage system of a motor vehicle parked in a garage, from fuel imported into the garage from an adjacent external gas storage system or by pipeline from a distant supplier, or from fuel generated onsite within the garage. The fuel gas may be hydrogen, natural gas, or a volatile light hydrocarbon such as propane, butane, or liquefied petroleum gas (LPG). An enclosed space is defined herein as a closed volume which has insufficient exchange of air with the surrounding atmosphere such that flammable gas buildup can occur in the enclosed space. The enclosed space may be, for example, a standalone building such as a garage, shed, or process building; a portion of a building such as a basement, utility room, attached garage, or laboratory; or an enclosed volume in a car, bus, truck, boat, train, or plane in which a flammable gas may accumulate.

Embodiments of the invention include a method for detecting and controlling the concentration of a flammable gas in the enclosed space. A source of flammable gas is provided to the enclosed space, and the enclosed space includes a device which consumes or stores the flammable gas. The enclosed space further includes unclassified electrical equipment and an electrical power supply to the unclassified electrical equipment. The atmosphere in the enclosed space is analyzed to determine the concentration of the flammable gas, and the concentration of the flammable gas determined is compared to a first reference concentration and a second reference concentration that is less than the first reference concentration. When the concentration of the flammable gas in the enclosed space is between the first and second reference concentrations, the source of flammable gas to the enclosed space is terminated and the enclosed space is ventilated. When the concentration of the flammable gas in the enclosed space is equal to or greater than the first reference concentration, the electrical power supply to the unclassified electrical equipment in the enclosed space is de-energized, i.e., the power to the unclassified electrical equipment is shut off.

The concentration of the flammable gas typically is determined as a % of the lower flammable limit (LFL) of the flammable gas in ambient air. The first reference concentration preferably is greater than about 25% and less than 100% of the LFL, and the second reference concentration is greater than about 5% of the LFL and equal to or less than the first reference concentration. The flammable gas may be selected from hydrogen, methane, natural gas, propane, butane, and liquefied petroleum gas (LPG).

In one embodiment, the gas may be hydrogen used as the primary fuel for a fuel cell in an automotive vehicle or a stationary power generation system. This hydrogen may be stored within the vehicle as a compressed gas or as a metal hydride in a reversible metal hydride storage system. The vehicle may be fueled at a remote commercial fueling site and parked in a garage. Alternatively, the vehicle may be fueled within the garage by hydrogen generated onsite by water electrolysis or the reforming of commercially-available hydrocarbons such as natural gas, propane, butane, liquefied petroleum gas (LPG), or gasoline. Hydrogen for a fuel cell power generation system likewise may be generated onsite by the reforming of these commercially-available hydrocarbons. In either of these alternatives, hydrogen may be piped into the garage or process building from an adjacent liquid or compressed gas storage system or from an adjacent hydrogen generation system. Accumulation of flammable gas may occur in the garage or process building because of hydrogen leaks in the hydrogen storage or refueling system, or alternatively because of leaks in the hydrocarbon supply to the reforming system.

In another embodiment, light hydrocarbons, particularly natural gas, may be stored as a compressed gas in a vehicle having an internal combustion engine designed to operate on compressed natural gas (CNG). The vehicle may be fueled at a remote commercial fueling site or alternatively fueled within the garage or enclosed space by compressing natural gas imported into the garage or enclosed space. Accumulation of flammable gas may occur in the garage or enclosed space because of natural gas leaks in the gas storage or refueling system.

Other embodiments can be envisioned in which hydrogen, propane, butane, or LPG is stored in a motor vehicle having an internal combustion engine designed to operate on one of these fuels.

Hydrogen is a flammable gas that can be ignited in ambient air at a minimum concentration of 4.1 volume %. This concentration defines the lower flammable limit (LFL) of hydrogen in ambient air. Because hydrogen has a lower gas density than air, hydrogen from leaks will tend to accumulate near the ceiling of a garage or enclosed space. Electrically-operated equipment such as garage door openers and exhaust fans, which are potentially sources of ignition, are typically installed near the ceiling, where leaking hydrogen tend to accumulate.

One exemplary embodiment of the invention includes a method and system to detect and mitigate hydrogen leaks in garages and other enclosed spaces. In an example to illustrate this embodiment, hydrogen is generated inside a garage by a hydrogen generator such as, for example, a water hydrolysis system or a small reformer operating on natural gas or other hydrocarbon. The garage may be fitted with a typical garage door opener mounted on the ceiling and may have a ventilating fan installed near the ceiling in an outside wall. The generated hydrogen is utilized to fuel an vehicle having a fuel cell drive system or an internal combustion engine designed to operate on hydrogen. The vehicle is parked in the garage and utilizes an onboard metal hydride-based fuel storage system. The atmosphere in the enclosed space is regularly sampled at the most likely location for hydrogen to accumulate, typically at ceiling level above the source of a hydrogen leak. A multiple-level warning and activation system operates continuously, and provides alarm notifications and process actions at multiple hydrogen concentration levels below the LFL. At one of these alarm levels, a warning may be given to the owner or operator. At another alarm level, ventilation may be initiated by activating a garage door opener and/or by activating a forced air ventilation system. The hydrogen generator may be shut down at one of these alarm levels. At another of these alarm levels, the electrical power supply to unclassified electrical equipment (i.e., equipment which can provide a source of ignition) may be deactivated.

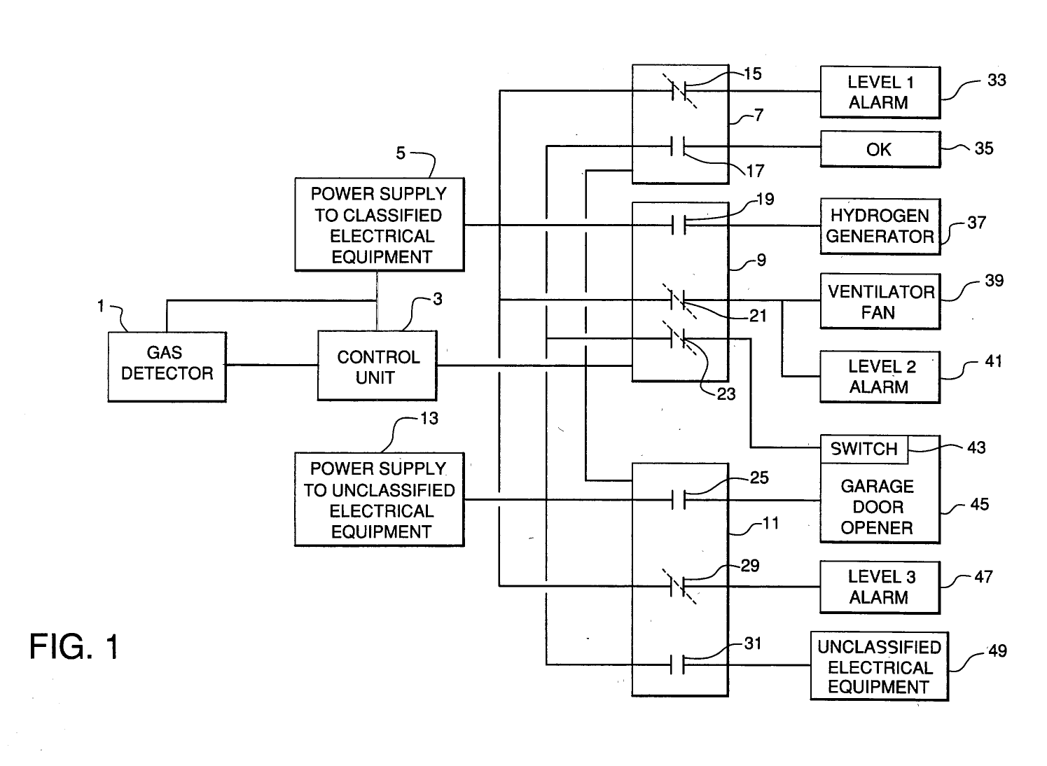

An exemplary alarm and safety operating system for this embodiment illustrated schematically in FIG. 1. Hydrogen gas detector 1 samples and analyzes the atmosphere near the ceiling of the garage in the vicinity of the hydrogen generator and piping to the vehicle having a hydrogen storage system. Hydrogen gas detector 1 can utilize any known type of hydrogen sensor such as, for example, a Pd-based sensor disclosed in U.S. Pat. No. 6,293,137 or a Ni—Pd alloy sensor disclosed in U.S. Pat. No. 5,279,795. A thermal conductivity cell also can be used in this service. Gas detector 1 generates a signal in proportion to the hydrogen concentration in the sampled air and the signal is transmitted to control unit 3. Gas detector 1 and control unit 3 preferably are powered by power supply 5. Gas detector 1, control unit 3, and power supply 5 should be certified for service in a hazardous area as defined by NFPA 70, National Electrical Code, Class 1, Divisions 1 and/or 2.

Control unit 3 typically includes a microprocessor system which compares the signal from gas detector 1 with stored information relating this signal to the concentration of hydrogen in air. The signal can be converted in control unit 3 to a concentration that is expressed as volume % or alternatively as an equivalent fraction or percent of the LFL (% LFL). This concentration can be compared to previously specified critical levels, either as volume % or as % LFL; if these levels are exceeded, certain actions can be taken as described below. Output signals from control unit 3 operate a plurality of power relays 7, 9, and 11, each of which houses a plurality of contacts. Each of the contacts in these relays may be normally closed and transmitting power, i.e., normally on, or normally open and not transmitting power, i.e., normally off. When power is supplied to a power relay, i.e., when the relay is energized, each contact in the relay is in its normal state. When power to a relay is terminated, i.e., when the relay is de-energized, each contact is in its alternative state. If a contact is normally on, its alternative state is off; conversely, if a contact is normally off, its alternative state is on. Power to energize relays 7, 9, and 11 is provided by electrical power supply 5 via control unit 3. Power to the contacts in the relays is provided by electrical power supplies 5 and 13 as shown.

Electrical power supply 5 provides power to classified electrical equipment, which is defined as electrical equipment that is certified for service in a hazardous area as defined by NFPA 70, National Electrical Code, Class 1, Divisions 1 and/or 2. Electrical equipment includes any electrically-energized apparatus which may provide an ignition source in a flammable atmosphere. Such equipment may include, for example, motors, lighting equipment, switches, and sensors. Power is provided by electrical power supply 5 to contact 15 (which is normally off) in relay 7, to contact 19 (normally on) and contact 21 (normally off) in relay 9, and to contact 29 (normally off) in relay 11. Electrical power supply 5 typically includes breakers, switchgear, and wiring, and is certified for service in a hazardous area as defined by NFPA 70, National Electrical Code, Class 1, Divisions 1 and/or 2. Electrical power supply 5 typically is rated as either intrinsically safe (IS) or explosion proof (EP) and therefore can be used safely in a flammable atmosphere. Alternatively, power supply 5 may be located outside of the enclosed area.

Electrical power supply 13 provides power to unclassified electrical equipment, which is defined as electrical equipment that is not certified for service in a hazardous area as defined by NFPA 70, National Electrical Code, Class 1, Divisions 1 and/or 2. Electrical equipment includes any electrically-energized apparatus which may provide an ignition source in a flammable atmosphere. Such equipment may include, for example, motors, lighting equipment, switches, and sensors. In a typical garage, a garage door opener, lights, power outlets, appliances, and electrical tools are defined as unclassified electrical equipment. Electrical power supply 13 typically includes breakers, switchgear, and wiring, and is certified for service in a hazardous area as defined by NFPA 70, National Electrical Code, Class 1, Divisions 1 and/or 2. Power from electrical power supply 13 is provided to contact 17 (normally on) in relay 7, contact 23 (normally off) in relay 9, and contact 25 (normally on) and contact 31 (normally on) in relay 11.

Power from contact 15 (normally off) is provided to level 1 alarm 33 and power from contact 17 (normally on) is provided to OK status indicator 35. Power from contact 19 (normally on) is provided to hydrogen generator 37 and power from contact 21 (normally off) is provided to garage ventilator fan 39 and level 2 alarm 41. Power from contact 23 (normally off) is provided to switch 43 that operates garage door opener 45. Switch 43 can be manually operated (not shown) for normal garage door operation. Power from contact 25 (normally on) is provided to garage door opener 45. Power from contact 29 (normally off) is provided to level 3 alarm 47 and power from contact 31 (normally on) is provided to unclassified electrical equipment 49.

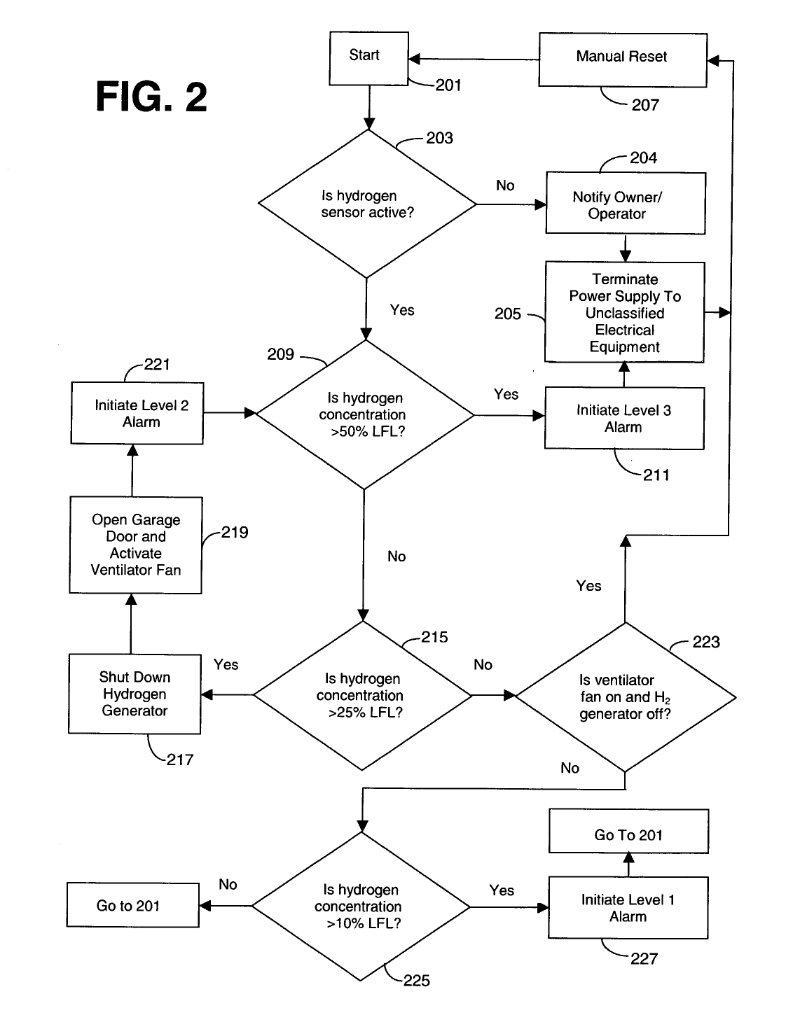

The operation of the system of FIG. 1 according to an exemplary embodiment of the invention is illustrated in the decision analysis diagram of FIG. 2. The process is initiated at step 201. At decision step 203, the status of the hydrogen sensor in gas detector 1 (FIG. 1) is checked to ensure that the sensor is activated. If the sensor is not activated, relays 7, 9, and 11 are de-energized and the owner/operator is notified of this situation in step 204 by an deactivated OK status indicator 35 and activated level alarms 1, 2, and 3 (33, 41, and 47, respectively). The owner/operator of the system must check, repair if necessary, and reactivate the sensor. The system then is reset at manual reset step 207 and the operation is initiated again at step 201.

If the hydrogen sensor is properly activated, control unit 3 utilizes the hydrogen detection signal from gas detector 1 to determine the equivalent % of the hydrogen lower flammable limit (LFL) and compares this value to the predetermined value of 50% in decision step 209. If this value is greater that 50% of the LFL, control unit 3 deactivates relay 11, thereby terminating power to garage door opener 45 and unclassified electrical equipment 49 in step 205, activates level 3 alarm 47 (step 211), and notifies the owner/operator of the problem in step 204. When the problems causing this action are fixed, the owner/operator must reset the system at step 207 and restart at step 201.

Alternatively, control unit 3 may utilize the hydrogen detection signal from gas detector 1 to determine the volume % of hydrogen in the garage and compare this to a predetermined value of the concentration in volume %. In this example, the detected volume % would be compared to a predetermined value of 2 volume % and actions would be initiated as described above.

In this exemplary embodiment, if the hydrogen concentration is less than 50% of the LFL in decision step 209, the system proceeds to decision step 215, in which control unit 3 utilizes the hydrogen detection signal from gas detector 1 to determine the equivalent % of the hydrogen lower flammable limit (LFL) and compares this value to the predetermined value of 25%. If this value is greater than 25% of the LFL, control unit 3 will de-energize relay 9, and thereby shutting down hydrogen generator 37 according to step 217. In addition, according to step 219, de-energizing relay 9 will activate switch 43 and open the garage door by means of garage door opener 37 and activate ventilator fan 39. In addition, level 2 alarm 41 will be activated to notify the owner/operator of the alarm status. The system returns to decision step 209 and proceeds as described above.

Alternatively, control unit 3 may utilize the hydrogen detection signal from gas detector 1 to determine the volume % of hydrogen in the garage and compare this to a predetermined value of the concentration in volume %. In this example, the detected volume % would be compared to a predetermined value of 1 volume % and actions would be initiated as described above.

If the hydrogen concentration is less than 25% of the LFL in decision step 215, the system proceeds to decision step 223, which determines if ventilator fan 39 is on and if hydrogen generator 37 is off. If the forced ventilation system is on and the hydrogen generator is off, this means that a hydrogen concentration of greater than 25% of the LFL was previously detected and steps 217, 219, and 221 were previously taken. The owner/operator then must manually reset the system at step 207 to restart hydrogen generator 37 and turn off ventilator fan 39. If decision step 223 indicates that ventilator fan 39 is not on and hydrogen generator 37 is operating, the system proceeds to decision step 225.

In decision step 225, control unit 3 utilizes the hydrogen detection signal from gas detector 1 to determine the equivalent % of the hydrogen lower flammable limit (LFL) and compares this value to the predetermined value of 10%. If this value is greater than 10% of the LFL, control unit 3 de-energizes relay 7 in step 227, which activates level 1 alarm 33 to warn the owner/operator that a hydrogen concentration above 10% and below 25% of the LFL has been detected. This also deactivates OK status indicator 35. The system then returns to initiation step 201. If the hydrogen concentration is less than 10% of the LFL, the system returns to initiation step 201 and continues the cycle by continuing to energize relays 7, 9, and 11. Decision step 225 and level 1 alarm 41 are optional.

Alternatively, control unit 3 may utilize the hydrogen detection signal from gas detector 1 to determine the volume % of hydrogen in the garage and compare this to a predetermined value of the concentration in volume %. In this example, the detected volume % would be compared to a predetermined value of 0.4 volume % and actions would be initiated as described above.

The cycle time of the system in normal operation, i.e., as it repeatedly executes decision steps 201, 203, 209, 215, 223, and 225 when the hydrogen sensor is active and the hydrogen concentration is less than 10% of the LFL, is typically between 1 and 100 milliseconds. Because of this rapid cycle time, a leak which causes a rising hydrogen concentration will trigger a “yes” decision first in decision step 225, next in decision step 215 (if the leak continues), and finally in decision step 209 (if the leak still continues). Thus during a continuing hydrogen leak the alarms and process actions will cascade upward from decision step 225 to decision step 209. This means, for example, that initiating the level 3 alarm in step 211 and terminating the power to unclassified equipment in step 205 will always be preceded by steps 217, 219, and 221. In this situation, after the problem that caused the alarms is rectified, manual reset step 207 will include energizing relays 7, 9, and 11, restarting hydrogen generator 37, and shutting off ventilator fan 39.

The % LFL levels which initiate alarms and activate process steps may be set more conservatively than the 10%, 25%, and 50% levels described above. For example, more conservative settings may include a level 1 alarm set at 5% of the LFL, a level 2 alarm at 15% of the LFL, and a level 3 alarm at 30% of the LFL. Alternatively, the % LFL levels which initiate alarms and activate process steps may be set less conservatively than the 10%, 25%, and 50% levels described above. Any combination of settings may be used such that the % LFL settings increase from the level 1 alarm to the level 2 alarm to the level 3 alarm. As noted above, the level 1 alarm is. optional.

Alternative embodiments of the invention may be applied to flammable gases other than hydrogen. For example, a vehicle having an internal combustion engine which operates on compressed natural gas (CNG) may be parked and/or refueled in a garage equipped with an alarm and safety operating system similar to that illustrated schematically in FIG. 1. Hydrogen generator 37 would be replaced with a natural gas refueling system that utilizes natural gas supplied by pipeline and step 217, which shuts down the hydrogen generator, would be replaced with a step in which pressurized gas flow into the garage would be terminated. Gas detector 1 would use a flammable gas sensor calibrated for natural gas and would sample and analyze the atmosphere near the ceiling of the garage in the vicinity of the vehicle and refueling system as described above. Any type of known flammable gas sensor can be used, such as, for example, the 350 Series Long-Life Natural Gas Sensor or the model CGO-321 Gas-Sentry Natural Gas Detector available from Bascom-Turner Instruments, Inc. Control unit 3 would include a microprocessor system which compares the signal from gas detector 1 with stored information relating this signal to the concentration of natural gas in air. The gas concentration can be converted in control unit 3 to an equivalent fraction or percent of the LFL, and this value can be compared to previously specified critical levels; if these levels are exceeded, actions can be taken as in the embodiment described above. The LFL for a typical natural gas in ambient air is 5 volume %.

In this embodiment, the natural gas may be compressed and/or stored outdoors and brought into the garage via pressurized piping to fill the vehicle storage cylinders. If a leak is detected during a refueling operation, and the gas concentration in the garage exceeds a predetermined % of the LFL, flow through the pressurized piping would be shut off, the garage door opened, and the ventilator fan activated. The alarm and safety operating system thus would operate in similar fashion to that described earlier and illustrated schematically in FIG. 1.

Embodiments of the invention may be applied to other light hydrocarbons such as propane, butane, or liquefied petroleum gas (LPG) which are stored and/or used in an enclosed space. The presence of these light hydrocarbons in air as a result of leaks can be readily monitored by known types of flammable gas detectors, and this information can be utilized in an alarm and safety operating system similar to that illustrated schematically in FIG. 1 and described above for handling compressed natural gas.

1. A method for detecting and controlling the concentration of a flammable gas in an enclosed space comprising:
(a) providing a source of flammable gas to an enclosed space, wherein the enclosed space includes a device which consumes or stores the flammable gas, and wherein the enclosed space further includes unclassified electrical equipment and an electrical power supply to the unclassified electrical equipment;
(b) analyzing the atmosphere in the enclosed space to determine the concentration of the flammable gas therein;
(c) comparing the concentration of the flammable gas determined in (b) to a first reference concentration and a second reference concentration that is less than the first reference concentration;
(d) when the concentration of the flammable gas in the enclosed space is between the first and second reference concentrations, terminating the source of flammable gas to the enclosed space and ventilating the enclosed space; and
(e) when the concentration of the flammable gas in the enclosed space is equal to or greater than the first reference concentration, de-energizing the electrical power supply to the unclassified electrical equipment in the enclosed space.

2. The method of claim 1 wherein the concentration of the flammable gas is determined as a % of the lower flammable limit (LFL) of the flammable gas in ambient air.

3. The method of claim 2 wherein the first reference concentration is greater than about 25% and less than 100% of the LFL and the second reference concentration is greater than about 5% of the LFL and equal to or less than the first reference concentration.

4. The method of claim 1 wherein the flammable gas is selected from the group consisting of hydrogen, methane, natural gas, propane, butane, and liquefied petroleum gas (LPG).

5. The method of claim 4 wherein the flammable gas is hydrogen.

6. The method of claim 5 wherein the first reference concentration is greater than about 25% and less than 100% of the LFL and the second reference concentration is greater than about 5% of the LFL and equal to or less than the first reference concentration.

7. The method of claim 5 wherein the source of flammable gas is a hydrogen generator selected from the group consisting of a water electrolysis unit and a hydrocarbon reforming unit.

8. The method of claim 5 wherein the source of the flammable gas is a pipeline that transfers hydrogen into the enclosed space from a storage facility outside the enclosed space.

9. The method of claim 1 wherein the enclosed space is a garage and ventilation is effected by opening a garage door and activating a ventilator fan.

10. The method of claim 1 which further comprises comparing the concentration of the flammable gas determined in (b) to a third reference concentration which is less than the second reference concentration, and actuating a warning alarm when the concentration of the flammable gas in the enclosed space is equal to or less than the second reference concentration and greater than the third reference concentration.

11. The method of claim 1 which further comprises actuating a warning alarm when the concentration of the flammable gas in the enclosed space is between the first and second reference concentrations.

12. The method of claim 11 which further comprises actuating a warning alarm when the concentration of the flammable gas in the enclosed space is equal to or greater than the first reference concentration.

13. A system for detecting and controlling the concentration of a flammable gas in an enclosed space comprising:
(a) means for providing a source of flammable gas to the enclosed space, wherein the enclosed space includes a device which consumes or stores the flammable gas, and wherein the enclosed space further includes unclassified electrical equipment and an electrical power supply to the unclassified electrical equipment;
(b) means for analyzing the atmosphere in the enclosed space to determine the concentration of the flammable gas therein;
(c) means for comparing the concentration of the flammable gas determined in (b) to a first reference concentration and a second reference concentration less than the first reference concentration;
(d) means for terminating the source of flammable gas to the enclosed space and ventilating the enclosed space in response to a first signal generated when the concentration of the flammable gas in the enclosed space is between the first and second reference concentrations; and
(e) means for de-energizing the power supply to the unclassified electrical equipment in response to a second signal when the concentration of the flammable gas in the enclosed space is equal to or greater than the first reference concentration.

14. A method for detecting and controlling the concentration of hydrogen in a garage in which hydrogen is utilized, the method comprising:
(a) providing a source of hydrogen to the garage, wherein the garage includes a device which consumes or stores hydrogen, and wherein the garage further includes unclassified electrical equipment and an electrical power supply to the unclassified electrical equipment;
(b) analyzing the atmosphere in the garage to determine the concentration of hydrogen therein;
(c) comparing the concentration of hydrogen determined in (b) to a first reference concentration and a second reference concentration less than the first reference concentration;
(d) when the concentration of hydrogen in the enclosed space is between the first and second reference concentrations, terminating the source of hydrogen to the enclosed space and ventilating the garage; and
(e) when the concentration of hydrogen in the enclosed space is equal to or greater than the first reference concentration, de-energizing the power supply to the unclassified electrical equipment.

15. The method of claim 14 wherein concentration of hydrogen is determined as a % of the lower flammable limit (LFL) of hydrogen in ambient air.

16. The method of claim 15 wherein the first reference concentration is greater than about 25% and less than 100% of the LFL and the second reference concentration is greater than about 5% of the LFL and equal to or less than the first reference concentration.

17. The method of claim 15 wherein ventilation of the garage is effected by opening a garage door and activating a ventilator fan.

18. An automatic garage door opener and ventilator system for a garage in which a flammable gas is utilized, the system comprising:
(a) means for providing a source of flammable gas to the garage, wherein the enclosed space includes a device which consumes or stores the flammable gas, and further includes unclassified electrical equipment and an electrical power supply to the unclassified electrical equipment;
(b) means for analyzing the atmosphere in the enclosed space to determine the concentration of the flammable gas therein;
(c) means for comparing the concentration of the flammable gas determined in (b) to a first reference concentration and a second reference concentration less than the first reference concentration;
(d) means for terminating the source of flammable gas to the enclosed space in response to a first signal generated when the concentration of the flammable gas in the garage is between the first and second reference concentrations;
(e) a garage door and garage door opening means for opening the garage door in response to the first signal generated when the concentration of the flammable gas in the garage is between the first and second reference concentrations;
(f) a ventilator fan for discharging air from the garage in response to the first signal generated when the concentration of the flammable gas in the enclosed space is between the first and second reference concentrations; and
(e) means for de-energizing the power supply to the unclassified electrical equipment in response to a second signal when the concentration of the flammable gas in the garage is equal to or greater than the first reference concentration.

19. The system of claim 18 wherein the flammable gas is hydrogen.

20. The system of claim 18 wherein the source of flammable gas is a hydrogen generator selected from the group consisting of a water electrolysis unit and a hydrocarbon reforming unit.

21. The system of claim 18 wherein the source of the flammable gas is a pipeline that transfers hydrogen into the enclosed space from a storage facility outside the enclosed space.
